(19) United States
(12) Patent Application Publication
(10) Pub. No.: US 2025/0314187 A1
(43) Pub. Date: Oct. 9, 2025

(54) DEVICE FOR HEATING EXHAUST GAS WHICH CAN FLOW IN AN EXHAUST GAS LINE

(71) Applicant: Schaeffler Technologies AG & Co. KG, Herzogenaurach (DE)

(72) Inventor: Wilfried MÜLLER, Lindlar (DE)

(21) Appl. No.: 18/872,944

(22) PCT Filed: Jun. 6, 2023
(86) PCT No.: PCT/EP2023/065070

§ 371 Date: Dec. 9, 2024

(30) Foreign Application Priority Data
Jun. 20, 2022 (DE) 10 2022 206 145.4

(51) Int. Cl. F01N 3/20; F01N 3/28

(52) U.S. Cl. CPC F01N 3/2013; F01N 3/281; F01N 3/2825; F01N 2240/16

(57) ABSTRACT

An apparatus for heating an exhaust gas stream from an exhaust gas source. The exhaust gas stream is flowable in an exhaust gas conduit and the apparatus for heating is arranged inside this exhaust gas conduit. The apparatus includes a heating disk formed from a honeycomb body of a plurality of foils. Some first foils are metallic and structured at least in sections and stacked on top of one another to afford a layer stack and are wound around at least one rotational axis to afford the honeycomb body. The heating disk formed by the honeycomb body forms at least one defined electrical conduction path along the first foils which is electrically contactable by at least one electrical contact. At least one of the foils is formed by a multilayer foil that alternately comprises metallic and ceramic layers.

### CROSS REFERENCE TO RELATED APPLICATIONS

This is a U.S. national stage of Application No. PCT/EP2023/065070 filed Jun. 6, 2023. Priority is claimed on German Application No. DE 10 2022 206 145.4 filed Jun. 20, 2022, the contents of which are incorporated herein by reference.

### BACKGROUND OF THE INVENTION

### 1. Field of the Invention

The disclosure relates to an apparatus for heating an exhaust gas stream from an exhaust gas source, in particular an internal combustion engine, wherein the exhaust gas stream is flowable in an exhaust gas conduit and the apparatus for heating is arranged inside this exhaust gas conduit, wherein the apparatus comprises a heating disk formed from a honeycomb body formed from a plurality of foils, wherein at least a number of first foils is metallic and structured at least in sections, wherein the foils are stacked on top of one another to afford a layer stack and are wound around at least one rotational axis to afford the honeycomb body, wherein the heating disk formed by the honeycomb body forms at least one defined electrical conduction path along the first foils which is electrically contactable by at least one electrical contact.

### 2. Description of the Related Art

To heat exhaust gas streams in exhaust gas systems of internal combustion engines electrical auxiliary heaters are employed to increase the exhaust gas temperature to a predetermined minimum value as quickly as possible. Attaining a system-dependent minimum temperature is necessary to ensure the correct functioning of the catalytic converters provided for exhaust gas aftertreatment. Depending on the construction, complete chemical conversion of the exhaust gas at the catalytic converter occurs only above a so-called light-off temperature. Especially after a cold start this light-off temperature must be attained particularly quickly to ensure that a conversion of the exhaust gas meeting the legal requirements for exhaust gas aftertreatment takes place.

One design of such electrical auxiliary heaters known in the prior art is a heating disk formed from a honeycomb body. The heating disk is preferably formed from a layer stack which is wound to afford a honeycomb body. In order to produce a clear current path the individual layers of the heating disk are spaced apart from one another with air gaps. These air gaps are generally a few millimeters wide to prevent unwanted contacting of the layers even during operation.

The disadvantage of the prior art apparatuses is especially that producing and generating these air gaps, especially in the case of honeycomb bodies of relatively large diameter, is very complex and costly. The air gaps also provide a kind of flow bypass for the exhaust gas. A certain amount of exhaust gas thus always flows past the heated structure of the heating disk, thus making the heating sub-optimal. In addition, the conversion of the exhaust gas at the heating disk acting as a catalytic converter itself is reduced.

Further disadvantages of the air gaps in the heating disk include the fact that they reduce the stability of the heating disk, thus making it especially susceptible to natural vibrations which can lead to contacting of the layers or destruction of the heating disk. To prevent this a multiplicity of support pins is used to support the heating disk with respect to a supporting structure, for example an upstream or downstream catalytic converter. These support pins significantly increase system costs and are an additional source of failure. Furthermore, vibrations from the supporting structure can be transmitted to the heating disk via the support pins which can damage the heating disk or cause a short circuit.

### SUMMARY OF THE INVENTION

One aspect of the present invention is providing a heating disk for heating an exhaust gas stream that comprises no open air gaps and thus eliminates the known weaknesses of prior art heating disks. Objectives include in particular a cost reduction in production, increasing the natural frequency of the heating disk, improving exhaust gas conversion through a lack of flow bypass and simplifying manufacturing.

One aspect of the invention relates to an apparatus for heating an exhaust gas stream from an exhaust gas source, in particular an internal combustion engine, wherein the exhaust gas stream is flowable in an exhaust gas conduit and the apparatus for heating is arranged inside this exhaust gas conduit, wherein the apparatus comprises a heating disk formed from a honeycomb body formed from a plurality of foils, wherein at least a number of first foils is metallic and structured at least in sections, wherein the foils are stacked on top of one another to afford a layer stack and are wound around at least one rotational axis to afford the honeycomb body, wherein the heating disk formed by the honeycomb body forms at least one defined electrical conduction path along the first foils which is electrically contactable by at least one electrical contact, wherein at least one of the foils is formed by a multilayer foil, wherein the multilayer foil alternately comprises metallic and ceramic layers.

The foils of the honeycomb body may preferably be completely smooth, partially structured or completely structured. Especially the structured sections may exhibit corrugations of different amplitude and corrugation frequency. It is thus possible to employ corrugated foils having a high corrugation height, so-called macrostructures, and corrugated foils having relatively small corrugation heights, so-called microstructures.

The stacking of smooth/microstructured foils and macrostructured foils on top of one another produces a honeycomb pattern, wherein flow channels are formed between the respective adjacent foils. The winding of the layer stack produces a honeycomb body having two substantially smooth end faces, wherein the flow channels run from one end face to the other end face and are traversable along a main flow direction.

The individual foils of the honeycomb body are preferably durably joined to one another, for example by soldering, preferably after winding and optionally after insertion in a shell. This comprises applying by suitable methods a soldering material which is melted in a soldering furnace in order thus to produce a durable join.

A multilayer foil is characterized in that it is formed from a plurality of layers. In the case according to the invention the multilayer foil preferably comprises five layers. A metallic layer, for example a metal foil or a fabric, is arranged centrally. This is provided on both sides with a ceramic layer. The ceramic layer is used for electrical insulation of the metallic layers arranged adjacent to one another.

Metallic layers follow the ceramic layers on both sides. These then form the outwardly visible outer surfaces of the multilayer foil. The metallic outer layer is particularly advantageous since this makes it possible to achieve bonding to adjacent foils of the honeycomb body. The multilayer foil may be easily joined to the purely metallic foils by the same operating step as the other foils.

The central metallic layer gives the multilayer foil the necessary stability, wherein the multilayer foil is preferably also designed so flexibly that very small bending radii, preferably about 1 mm, may be achieved. The ceramic layers ensure electrical insulation, with the result that unwanted electrical conduction across the multilayer foil is efficaciously prevented.

The outer metallic layers represent the contact layers by which the multilayer foil may be bonded to the remaining foils.

In the simplest case the multilayer foil may be formed from only three layers, wherein a central ceramic layer is provided and respective metallic layers follow therefrom. Alternative configurations may also comprise for example seven or nine layers provided that the basic concept of at least one ceramic layer in the center and respective metallic layers as outer layers is observed.

The layer stack composed of the metallic foils and the multilayer foil may be easily wound to afford a honeycomb body. The multilayer foil ensures that the honeycomb body comprises mutually electrically insulated layers which form a current path running from an inflow site to an outflow site. The otherwise customary air gap in the heating disk is omitted and no longer necessary due to the use of the multilayer foil.

It is particularly advantageous when the multilayer foil comprises five individual layers, wherein the multilayer foil comprises a metallic core which is covered on both sides with a ceramic layer, wherein a further metallic layer follows the ceramic layer.

Five layers are advantageous since this provides a central metallic layer to produce the stability of the multilayer foil. Two ceramic layers on both sides for electrical insulation and in turn two metallic layers on both sides for joining the multilayer foil to the remaining foils of the layer stack.

It is also advantageous when the multilayer foil is smooth and arranged between two mutually adjacent at least partially structured first foils. The multilayer foil may function as a smooth foil and especially be arranged between two at least partially structured foils. It is also conceivable for a macrostructured foil to be arranged on one side and a microstructured foil to be arranged on the other side.

A preferred exemplary embodiment is characterized in that the multilayer foil is at least partially structured, especially corrugated, and arranged between two smooth first foils. The multilayer foil has technical properties which also allow it to be corrugated and to have a microstructure or a macrostructure molded into it. The multilayer foil may therefore be arranged in place of any other foil used in the layer stack.

It is also preferable when the layer stack comprises two multilayer foils which are spaced apart from one another via at least one first metallic foil.

A plurality of multilayer foils is particularly advantageous since this makes it possible to double the insulation effect. The two multilayer foils may for example be spaced apart from one another by a structured foil in the layer stack. It is also conceivable to produce two or more mutually independent electrical conductor paths by using two or more multilayer films.

It is additionally advantageous when the multilayer foil is durably joined at its metallic layers forming its outer surfaces with the directly adjacent first foils in the honeycomb body. The durable join is especially to be produced by a soldering process since this makes it possible to produce the join of the metallic foils to one another and of the multilayer foil to the metallic foils in one operation.

It is also advantageous when the apparatus additionally comprises a supporting catalytic converter formed by a honeycomb body, with respect to which the heating disk is supported, wherein the supporting catalytic converter is formed by the stacking and winding of a plurality of foils, wherein the supporting catalytic converter comprises at least one multilayer foil which protrudes beyond one of the end faces of the supporting catalytic converter along the main flow direction.

To advantageously position the heating disk in the exhaust gas conduit and in particular to prevent electrical contacting of other elements the heating disk may preferably be supported electrically insulated relative to a support structure, for example another honeycomb body.

According to one aspect of the invention the honeycomb body serving as a supporting catalytic converter may comprise at least one multilayer foil which, however, in contrast to the remaining metallic foils has a longer extent along the main flow direction of the honeycomb body and thus overhangs beyond the end face limiting the flow channels at least on one side.

This overhanging multilayer foil is then preferably part of the layer stack which forms the heating disk. Provided the supporting catalytic converter and the heating disk have an identical or at least very similar construction, especially with regard to the number of layers and the type of winding, both honeycomb bodies may be wound and then soldered in a common operation.

The multilayer foil thus assumes the supporting function of the heating disk to the supporting catalytic converter and simultaneously also the electrical insulation of the electrical conduction path of the heating disk itself and the electrical insulation of the heating disk from the supporting catalytic converter.

It is also advantageous when the multilayer foil protruding beyond the end face of the supporting catalytic converter is also part of the layer stack of the honeycomb body forming the heating disk. The heating disk and the supporting catalytic converter are thus firmly joined to one another and electrically insulated from one another in suitable fashion.

It is further advantageous when the heating disk is fixed and spaced apart relative to the supporting catalytic converter by the multilayer foil protruding beyond the supporting catalytic converter.

It is further advantageous when the multilayer foil of the supporting catalytic converter comprises five layers, wherein the middle layer is a metallic layer which has a ceramic layer on both sides, wherein respective metallic layers follow the ceramic layers.

Advantageous developments of the present invention are described in the dependent claims and in the following description of the figures.

### BRIEF DESCRIPTION OF THE DRAWINGS

The invention is more particularly elucidated hereinbelow on the basis of exemplary embodiments with reference to the figures. In the figures:

FIG. 1 is a sectional view through a multilayer foil, wherein the multilayer foil is shown once as a smooth foil and once as a structured foil;

FIG. 2 is a view of a layer stack comprising two multilayer foils;

FIG. 3 is a view of a layer stack with a corrugated multilayer foil;

FIG. 4 is a view of a layer stack with a smooth multilayer foil; and

FIG. 5 is a sectional view through a supporting catalytic converter with multilayer foils overhanging along the flow direction, wherein a heating disk is also shown spaced apart from the supporting catalytic converter.

### DETAILED DESCRIPTION OF THE PRESENTLY PREFERRED EMBODIMENTS

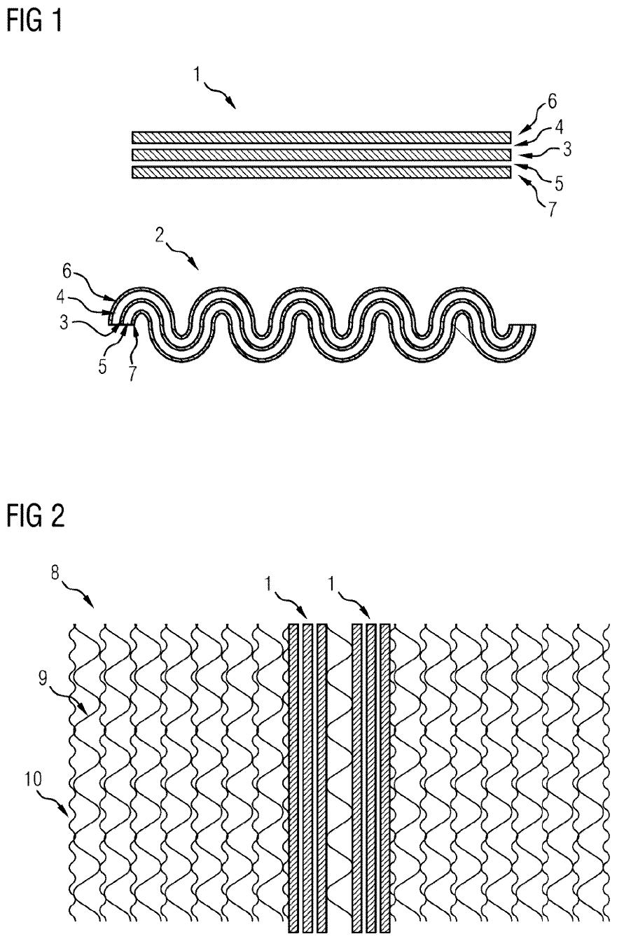

FIG. 1 shows in the upper region a multilayer foil 1 formed of five layers. The multilayer foil 1 is shown as smooth in the upper region of FIG. 1. The lower region of FIG. 1 shows a multilayer foil 2 which is structured, especially corrugated.

Both multilayer foils 1, 2 comprise five layers, wherein the central layer 3 is metallic and the two adjacent layers 4, 5 are ceramic. The respective outer layers 6, 7 are in turn metallic.

FIG. 2 shows a sectional view through a heating disk 8, wherein the heating disk 8 is formed from a plurality of metallic foils 9, 10. Arranged within the heating disk are two multilayer foils 1, wherein the outer layers 6, 7 of the multilayer foil 1 are in contact with the respective adjacent metallic foils 9, 10 and are durably joined to one another.

The two multilayer foils 1 are spaced apart from one another via a corrugated metallic foil 9. The heating disk shown in FIG. 2 is composed of roughly structured (macrostructured) foils 9 and finely structured (microstructured) foils 10.

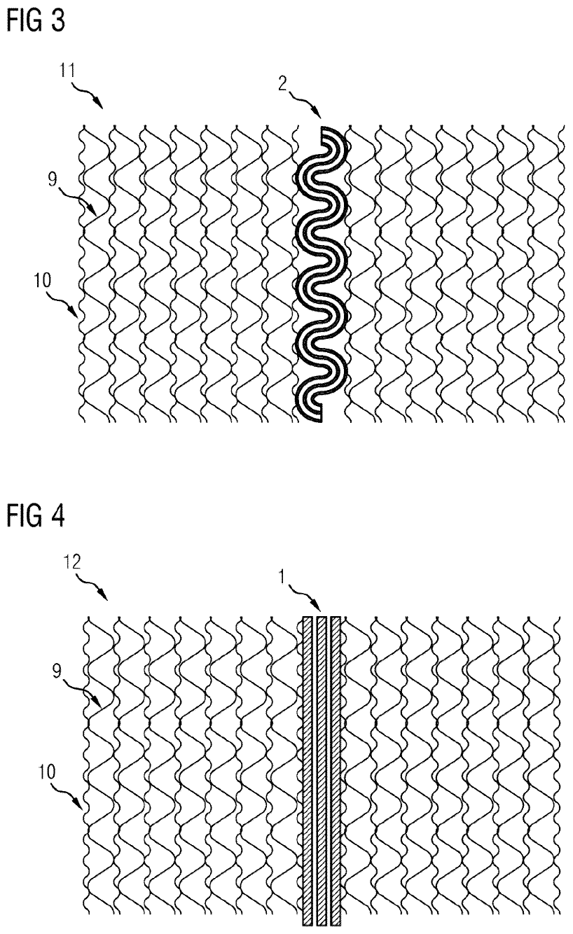

FIG. 3 shows a section through an alternative heating disk 11, wherein the heating disk 11 is likewise formed from macrostructured foils 9 and microstructured foils 10. The heating disk 11 comprises a multilayer foil 2, which is arranged between two microstructured foils 10.

FIG. 4 shows a further alternative heating disk 12, wherein the heating disk 12 is likewise formed from macrostructured foils 9 and microstructured foils 10. The heating disk 12 comprises a multilayer foil 1, which is arranged between two microstructured foils 10.

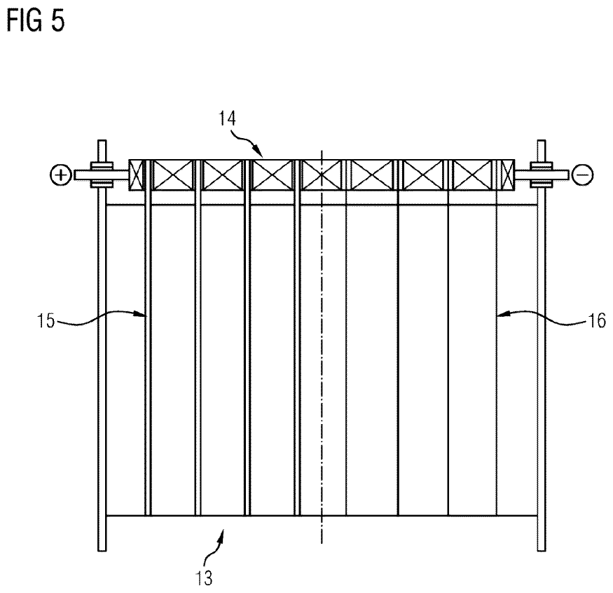

FIG. 5 shows a section through a supporting catalytic converter 13 formed from a wound layer stack. Shown above the supporting catalytic converter 13 is a heating disk 14 which is likewise formed from a wound layer stack.

In the left-hand portion of FIG. 5 the supporting catalytic converter 13 comprises a corrugated multilayer foil 15 which projects beyond the upper end face of the supporting catalytic converter 13. In the right-hand portion the supporting catalytic converter 13 comprises a smooth multilayer foil 16 which likewise projects beyond the upper end face. The supporting catalytic converter shown in FIG. 5 is exemplary and the different multilayer foils 15, 16 are intended to elucidate that both smooth and corrugated multilayer foils are possible. In one aspect the supporting catalytic converter 13 and the multilayer foils protruding beyond the end face would be configured uniformly over the entire cross section. The two-part view of FIG. 5 serves to elucidate the different possible configurations.

The different features of the individual exemplary embodiments can also be combined with one another.

The exemplary embodiments of FIGS. 1 to 5 especially have no limiting character and serve to illustrate the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. An apparatus for heating an exhaust gas stream from an exhaust gas source, wherein the exhaust gas stream is flowable in an exhaust gas conduit and the apparatus for heating is arranged inside this exhaust gas conduit, the apparatus comprises:
a heating disk formed from a honeycomb body formed from a plurality of foils;
wherein at least a number of first foils is metallic and structured at least in sections,
wherein the plurality of foils are stacked on top of one another to form a layer stack and are wound around at least one rotational axis to form the honeycomb body,
wherein the heating disk formed by the honeycomb body forms at least one defined electrical conduction path along the first foils which is electrically contactable by at least one electrical contact,
wherein at least one of the foils is formed by a multilayer foil, wherein the multilayer foil alternately comprises metallic and ceramic layers.

12. The apparatus as claimed in claim 11, wherein the multilayer foil comprises five individual layers, wherein the multilayer foil comprises a metallic core covered on both sides with a ceramic layer, wherein a further metallic layer follows the ceramic layer.

13. The apparatus as claimed in claim 11, wherein the multilayer foil is smooth and arranged between two mutually adjacent at least partially structured first foils.

14. The apparatus as claimed in claim 11, wherein the multilayer foil is at least partially structured and is arranged between two smooth first foils.

15. The apparatus as claimed in claim 11, wherein the layer stack comprises two multilayer foils (1) which are spaced apart from one another via at least one first metallic foil.

16. The apparatus as claimed in claim 11, wherein the multilayer foil is durably joined at its metallic layers forming its outer surfaces with directly adjacent first foils in the honeycomb body.

17. The apparatus as claimed in claim 11, wherein the apparatus further comprises:
a supporting catalytic converter formed by a honeycomb body, with respect to which the heating disk is supported,
wherein the supporting catalytic converter is formed by stacking and winding of a plurality of foils,
wherein the supporting catalytic converter comprises at least one multilayer foil which protrudes beyond one end face of the supporting catalytic converter along a main flow direction.

18. The apparatus as claimed in claim 17, wherein the multilayer foil protruding beyond the one end face of the supporting catalytic converter is also part of the layer stack of the honeycomb body forming the heating disk.

19. The apparatus as claimed in claim 17, wherein the heating disk is fixed and spaced apart relative to the supporting catalytic converter by the multilayer foil protruding beyond the supporting catalytic converter.

20. The apparatus as claimed in claim 17, wherein the multilayer foil of the supporting catalytic converter comprises five layers, wherein a middle layer is a metallic layer which has a ceramic layer on both sides, wherein respective metallic layers follow ceramic layers.

21. The apparatus as claimed in claim 14, wherein the multilayer foil is at least partially corrugated.
